(19) United States
(12) Patent Application Publication
(10) Pub. No.: US 2014/0058543 A1
(43) Pub. Date: Feb. 27, 2014

(54) METHOD FOR CONFIGURING A FIELD DEVICE AND CORRESPONDING FIELD DEVICE AND SYSTEM FOR PARAMETERIZATION

(71) Applicant: KROHNE MESSTECHNIK GMBH, Duisburg (DE)

(72) Inventors: Michael Gerding, Bochum (DE); Gerd Stettin, Unterreichenbach (DE)

(73) Assignee: KROHNE MESSTECHNIK GMBH, Duisburg (DE)

(21) Appl. No.: 13/682,003

(22) Filed: Nov. 20, 2012

(30) Foreign Application Priority Data
Aug. 21, 2012 (DE) 10 2012 016 403.3

(51) Int. Cl. G05B 15/02

(52) U.S. Cl. CPC G05B 15/02
USPC 700/83

(57) ABSTRACT

A method for configuring a field device (1), a corresponding field device and a corresponding parameterization system provide for the secure transfer of parameter values via a potentially unsafe data link by a control value that is dependent on at least one parameter value of the field device being determined and an output signal is generated. The output signal is output as a current signal via an interface (2) of the field device (1).

### BACKGROUND OF THE INVENTION

1. Field of the Invention

The invention relates to a method for configuring a field device, wherein at least one parameter value of the field device is adjustable and the field device has at least one interface. The invention further relates to a corresponding field device and a corresponding system for parameterization of a field device with a parameterization unit.

2. Description of Related Art

In modern process automation, field devices, e.g., are used as measuring instruments for monitoring process variables and as actuators for influencing the processes. The communication between the field devices among one another and, for example, between the field devices and a master control room is usually accomplished via field buses and using standardized communication protocols (e.g., HART or via 4 . . . 20 mA current signals). It is also occasionally provided that the field devices have their own display unit, which allows the display, for example, of measurement values on site.

For use of the field devices that is well adjusted to the processes or working conditions, a large number of parameter values can often be set or be provided. Standard values are often used for this purpose during production of the field devices or during initial startup. Depending on the relevance of the parameters or depending on the type of application, it is possible that some parameters cannot be modified or can only be changed after a release by a safety key.

In particular, in the use of the field devices in fields that are critical to safety, a correct setting of the parameter values must be guaranteed. The requirements for meeting the SIL standard (SIL=Safety Integrity Level), which is important especially in process automation, are relevant, if applicable, to the respective safety requirements.

In this context, for example, the German Patent Application DE 10 2004 055 971 and corresponding U.S. Pat. No. 7,912,990 B2 describe a method for configuration of a device. The parameter values are read back from the device to the parameterization unit at least once for control purposes.

The problem, however, is that, for communication between the field device and parameterization unit, possibly unsafe control paths or channels are used which could distort the transmitted data.

### SUMMARY OF THE INVENTION

A primary object of the present invention is, thus, to provide a method for configuring a field device—and a corresponding field device or a corresponding parameterization system—that enables secure transfer of parameter values via a potentially unsafe data link.

The method according to the invention, in which the described object is met, is characterized initially and essentially by the following steps:

At least one control value is determined, which is dependent on at least one parameter value of the field device. This control value can also be understood as a test value or checksum and possibly correspondingly determined. The control value can be determined, for example, in that it is calculated using a pre-definable formula, i.e., by setting the parameter value or possibly several parameter values with their numerical values in a predetermined formula, or—alternatively—in that the control value is taken via the parameter value of a pre-definable value table that is, in particular, conveniently stored in the field device. If several parameter values are used, this table is preferably multi-dimensional. In an additional design, the calculation and the use of data stored in tables are combined with one another. The determination of the control value takes place, in particular, in the field device and by the field device.

In the next step of the method, at least one output signal of the field device is generated, wherein the at least one output signal is dependent at least on the determined control value. The at least one generated output signal is output as a current signal via the interface of the field device, which is designed correspondingly for the output of current signals. The interface is, for example, access to a current loop.

In the method according to the invention, at least one parameter value or alternatively several parameter values of the field device are converted into a control value or are encrypted in it. This control value is—optionally in conjunction with other data or values, etc.—transferred into an output signal of the field device and output as a current signal. Conversely, as a result, the current signal, e.g., its amplitude or its frequency etc., carries the control value, so that the control value can be derived from the measured current signal. This opens up the possibility of safely transmitting the parameter values to the outside via a current output. In particular, it is an advantage that a current measuring device is sufficient for picking up the signals.

In the case that the field device is a measuring device, it is provided in one design that the at least one control value and/or the at least one output signal is generated depending on a measured value. In one design, this is an actual measured value, in an alternative design, a value measured previously to configuration and in a further design, a simulated measurement value. In particular, such a measurement value is used here, which is also known to the receiver side of the output signal or the measured value is selected according to a rule that is known to the receiver side.

In one design, at least two output signals are generated from at least one control value, which preferably differ from each other. The output signals can each be dependent on the same control value or on the same group of control values. A pre-definable variation scheme is used for the generation of the output signals, through which the control value can be inferred on the receiving side. The at least two output signals are output as current signals. In this design, the output safety and safety of receiving the correct data are increased in that multiple output takes place.

A particular variation scheme for the generation of the output signals is that the generated output signals lie between a pre-definable minimum value I_{MIN} and a pre-definable maximum value I_{MAX} with a pre-definable increment ΔI. A signal range spans through the minimum value I_{MIN} and the maximum value I_{MAX}, which, in one variation, corresponds to the signal range in which the signals, which are output during normal operation of the field device, lie. It is possible, for example, that a signal transmission through a current loop between 4 mA and 20 mA exists. The individual output signals lie between these limiting values and have a predetermined increment size to one another ΔI, for example in each case 10% increments of the total signal range.

In one design, additionally or alternatively, at least one output signal is generated such that it is outside a pre-definable signal range. Such pre-definable signal range, for example, is the range described in the preceding design, which lies in a variation between 4 mA and 20 mA. For the parameterization, an output signal is generated and output outside of this signal range, which is, in particular, a range used for normal operation of the field device.

In one design, the field device has at least one service interface for setting, in particular, several parameter values, at which, for example, a corresponding parameterization unit is connected. Alternatively, the field device has a display unit, which allows input of data, as a service interface.

One design relates to the interaction with the output signal or the output signals on the side receiving the output signal. The at least one output signal is received and at least one comparison value is determined from the at least one output signal. In the ideal case, the comparison value is equal to the control value or has a known relationship to it. Then, the determined comparison value is compared with at least one desired value. The desired value results, in particular, from the (desired) values that exhibit the parameter values in the field device, and possibly from other values, such as the measured value in the field device implemented as measuring device. Furthermore, the desired value may also be dependent on the above-mentioned variation scheme. The desired value is determined, in particular, according to the same algorithm, the same formula or the same table data, that is/are used for the control value. It can be seen from the comparison of desired and comparison values, whether the parameter value or the parameter values has/have been set correctly. In the case of conformity—possibly within a tolerance range—for example, parameterization can be completed on the field device by confirmation or a parameter value can be saved. In the case of deviation, parameterization may be repeated or another data link is created or the configuration is cancelled and the field device goes into a secure (default) state.

Alternatively or additionally, the parameter value or the parameter values are directly calculated from or derived from the comparison value.

The previously derived and described object is achieved according to another teaching of the invention by a field device for implementing the method according to one of the above designs. The field device is, in particular, an actuator or a measuring device.

According to an additional teaching of the invention, the previously derived and described object is achieved with the aforementioned system with a field device and a parameterization unit in that during the configuration of the field device, the method is carried out using at least one of the above designs of the method. The parameterization system is generated thereby possibly only temporarily, by using a parameterization unit with the field device for the time the configuration is connected. The parameterization unit is, for example, a control room, a (preferably portable) computer or a handheld mobile operator panel for field devices. As a simple variation, for example, the parameterization unit itself or a current measuring device is used for picking up the output signal or the output signals.

In detail, there are a variety of possibilities for designing and further developing the method according to the invention, the field device according to the invention and the system according to the invention as will be apparent from the following description of embodiments in conjunction with the accompanying drawings.

### BRIEF DESCRIPTION OF THE DRAWINGS

FIG. 1 is a schematic representation indicating essentially the functional relationship of a system for configuring a field device,

FIG. 2 is a graph indicating the generation of the output signal as a current signal, and

FIG. 3 is a flow chart of an exemplary implementation of the parameterization method.

### DETAILED DESCRIPTION OF THE INVENTION

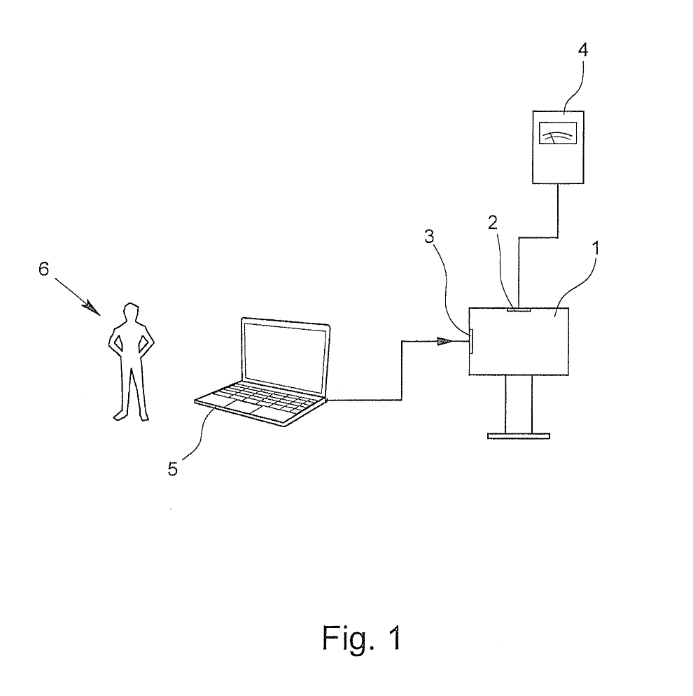

An embodiment of a parameterization system is shown in FIG. 1, wherein the relationships between the various elements are diagrammatically illustrated. In particular, FIG. 1 shows a field device 1 that is a fill level measuring device that operates according to the radar principle as an example. The field device 1 has an interface 2 that is used as a current output, e.g., for connection to a two-wire device or to a current loop. In the illustrated embodiment, a service interface 3 is also provided, via which parameters are set or program routines are controlled. The service interface 3 is provided, here, for connection to an electrical conductor. Alternatively, the service interface 3 is a direct input device of the field device, e.g., a touch display.

The field device 1 is connected with two devices for configuration. On the one hand, a current measuring device 4, which is used to measure output signals of the field device 1 in the form of current signals, is connected at the interface 2 for output of current signals. On the other hand, a parameterization unit 5—here in the form of a portable computer—is connected with the field device 1 via the service interface 3. The result is a system for parameterization of the field device 1 by an operator 6 that possibly exists only temporarily, e.g., while the parameterization unit 5 is connected.

The parameter values of the field device 1 are set via the service interface 3. It is provided in the field device 1 that some parameter values can be changed only after entering an access code or after the setting of specific parameters (that function, for example, as a kind of toggle switch). In order to ensure that the parameter values have been set correctly, in particular for applications critical to safety, a retrieval of the parameter values is carried out in the illustrated embodiment.

The output of the parameter values is carried out via the interface 2 by generating output signals as current signals. One advantage is, in particular, that the field device 1 does not have to have, e.g., a local display. In the system according to the invention, a current signal must simply be picked up and measured.

In order to implement an association between the parameter values and the output signal, or for example, its current, a control value in the field device 1 is determined based on at least one parameter value. This is carried out by a conveniently stored formula or via stored tables or a combination of both. From the control value, which is the carrier of information about at least one parameter value or about all or at least one set of parameter values designated optionally by their relevance to, e.g., safety, at least one output signal is, in turn, generated via a pre-definable association and output as current signal via the interface 2.

The output signal received, or here measured by the current measuring device 4 allows for the determining of a comparison value, which essentially corresponds to the control value during optimal transmission. Since the generation of the control value is carried out using previously known relationships, a desired value can be determined by the operator 6, if necessary, in conjunction with the parameterization unit 5, which, like the control value, reflects the parameter values.

If the reference value and the desired value agree with one another—possibly within a pre-definable tolerance range—, the operator 6 acknowledges the parameter values via the parameterization unit 5 or possibly the entire setting of the field device 1, which can be then used for measurement in the process.

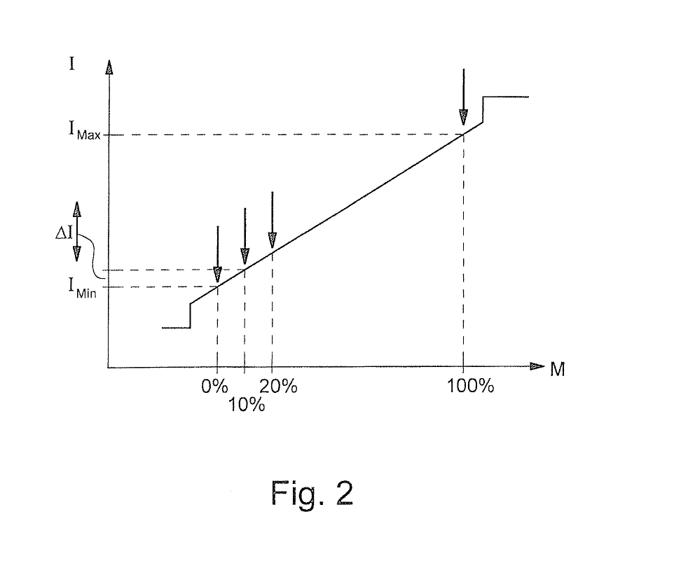

FIG. 2 shows a type of generation of output signals based on the 4 . . . 20 mA uniform signals of process automation.

The signal width of the current (I on the Y-axis of the graph) from 4 mA to 20 mA is used for transmitting measured values (M on the X-axis of the graph) for 4 . . . 20 mA signals or possibly even 0 . . . 20 mA signals, which are located between the smallest measured value (corresponding to 4 mA) and the maximum measured value (corresponding to 20 mA). For example, a linear relationship within this range can be used between the current and the measured value. A current of 12 mA would, therefore, mean that a measured value was measured that lies midway between the smallest and the largest expected measured value. If a current signal is generated outside of this range, this often signals the presence of a fault, which is why the term fault current exists.

The control value is accordingly scaled for transmission as output signal, so that it allows for a transfer as 4 . . . 20 mA signal. Here, in particular, several output signals are generated in that the range between 4 mA as minimum current I_{MIN} and 20 mA as maximum current signal I_{MAX} is scanned. The step size is set at 10% increments as an example. Therefore, the control value can be derived, if necessary, based on an interpolation of the measured output signals. Further, possible errors can be recognized like this during transmission, if e.g., deviations from the pre-determined variation scheme occur.

In one embodiment, output signals are also generated that lie outside the normal range—i.e., here, less than 4 mA or greater than 20 mA.

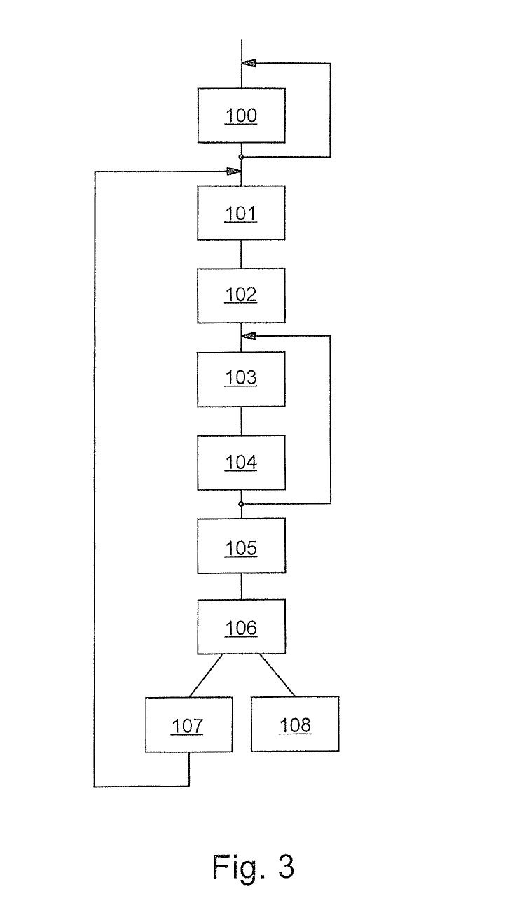

FIG. 3 shows a flowchart of the steps of the parameterization method, as implemented in the example of a system shown in FIG. 1 or in similarly designed parameterization systems. However, other step sequences or more steps are possible within the scope of the invention.

In step 100, a parameter value of field device is set via the parameterization unit. This step 100 is repeated several times, if necessary, when more than one parameter value is to be set. The access is also dependent on which parameter values are enabled for input. In an alternative embodiment, the steps following step 100 are executed for each input parameter value.

Based on the currently set parameter values or alternatively, all parameter values that can be entered in the field device, a control value can be determined in step 101 from the field device, in that, for example, data from tables stored in the field device and an associated and also conveniently stored formula are used.

In step 102, a desired value for the input parameter values is determined on the side of the operator or, in particular, in the parameterization unit. If, in particular, the same algorithm is used for determining the control value and the desired value and if the parameter values are properly transmitted and received, then, in this ideal case, there is agreement between the desired and control value. The desired values are stored, for example, in a manual.

The control and the desired values, for example, are also dependent on a measured value, insofar as the field device—as in the embodiment of FIG. 1—is a measuring device.

A fundamental relationship between the control value and a parameter value, which is reflected particularly clearly in a scaling value, for example, is given by the function:

Control value=(measured value*scale factor)*linearization—zero tolerance.

Here, the linearization takes the associated range for the signals into consideration and the zero tolerance means a shift of each scale used.

In step 103, the field device generates an output signal depending on the control value and outputs it as a current signal via a corresponding interface. In step 104, there is suitable current measurement at the used interface of the field device. In order to increase the reliability of transmission, the output signal is issued repeatedly corresponding to a variation sequence (step 103), and in each case, a current value is suitably measured (step 104).

A comparison value is then determined from the individual current values of the output signals or the current value of one output signal in step 105, which is compared to the desired value in step 106. If the two values agree, the correct parameter values have been set in the field device and the process can be terminated in step 107. If, in each case, only a subset of the parameter values is read back, there is a return to step 101 in the event of agreement, so that the control value can be determined for other parameter values and the further steps can be carried out. This is repeated accordingly until all predetermined parameter values have been controlled.

If the values differ over a pre-definable tolerance range, then troubleshooting begins in step 108.

What is claimed is:

1. Method for parameterization of a field device that has at least one adjustable parameter value and has at least one interface, comprising the steps of:
determining at least one control value that is dependent at least on the at least one adjustable parameter value,
generating at least one output signal of the field device dependent on at least the at least one control value, and
outputting the at least one output signal as a current signal via the interface of the field device.

2. Method according to claim 1, wherein the at least one output signal comprises at least two output signals are generated at least dependent on the at least one control value and as a function of a pre-definable variation scheme, and wherein at least the at least two output signals are output as current signals.

3. Method according to claim 2, wherein said at least two output signals are generated in such a way that the output signals lie between a pre-definable minimum value and a pre-definable maximum value with a pre-definable increment.

4. Method according to claim 1, wherein the at least one output signal is generated such that it is outside a pre-definable signal range.

5. Method according to claim 1, wherein the at least one adjustable parameter value comprises a plurality of adjustable parameter values of the field device and wherein at least one of said adjustable parameter values of the field device is adjusted via a service interface.

6. Method according to claim 1, wherein the field device is a measuring device and wherein at least one of the at least one control value and the at least one output signal is generated depending on a measured value.

7. Method according to claim 1, wherein the control value is determined by the at least one control value being calculated using one of a pre-definable formula and a pre-definable value table.

8. Method according to claim 1, wherein at least one output signal is received by a current measuring device, wherein at least one comparison value is determined from the at least one output signal, and wherein the determined comparison value is compared with at least one reference value.

9. Field device comprising:
at least one adjustable parameter value,
means for generating at least one output signal that dependent on at least at least one control value, and
at least two interfaces, a first of said interfaces being a current interface for outputting the at least one control value as a current signal and a second of said interfaces being a service interface via which at least one of parameters are settable and program routines are controllable.

10. Field device system, comprising:
a field device having at least one adjustable parameter value, means for generating at least one output signal that dependent on at least at least one control value, and at least two interfaces, a first of said interfaces being a current interface for outputting the at least one control value as a current signal and a second of said interfaces being a service interface via which at least one of parameters are settable and program routines are controllable, and
a parameterization unit at least temporarily connected to the service interface.

11. Field device system according to claim 10, wherein said parameterization unit comprises at least one of a control room, a computer and a handheld mobile operator panel.

12. Field device system according to claim 11, further comprising a current measuring device at least temporarily connected to said current interface.
